(19) United States
(12) Patent Application Publication
(10) Pub. No.: US 2011/0120900 A1
(43) Pub. Date: May 26, 2011

(54) Storage and dividing device for baby food powder with optional connection to food powder container or baby feeding bottle

(76) Inventor: Maya Nahum, Rison le ziyon (IL)

(21) Appl. No.: 12/948,799

(22) Filed: Nov. 18, 2010

(30) Foreign Application Priority Data
Nov. 23, 2009 (IL) 202276IL

(51) Int. Cl. B65D 85/84

(52) U.S. Cl. 206/524.1

(57) ABSTRACT

The present invention innovates with a device that enables storage of baby food powder, with the device having at least one connector enabling the device to be connected to a box of baby food powder, for example, as a cover, with the device being composed of at least two separable or fixed parts, which are enabled by rotating on their axis, in such way as the interior of the device that connects the two parts is hollow in part of its area, and thus enables pouring of the powder from the storage box, through the attachment, which is a part of the device attached to it, and which connects to the upper part of the device, and serves as a measuring unit as needed, and can be replaced with other measuring units, based on the user's needs and requirements. Optionally, the device can also be attached to the openings of baby bottles, where at least one storage compartment is used to store the baby food powder.

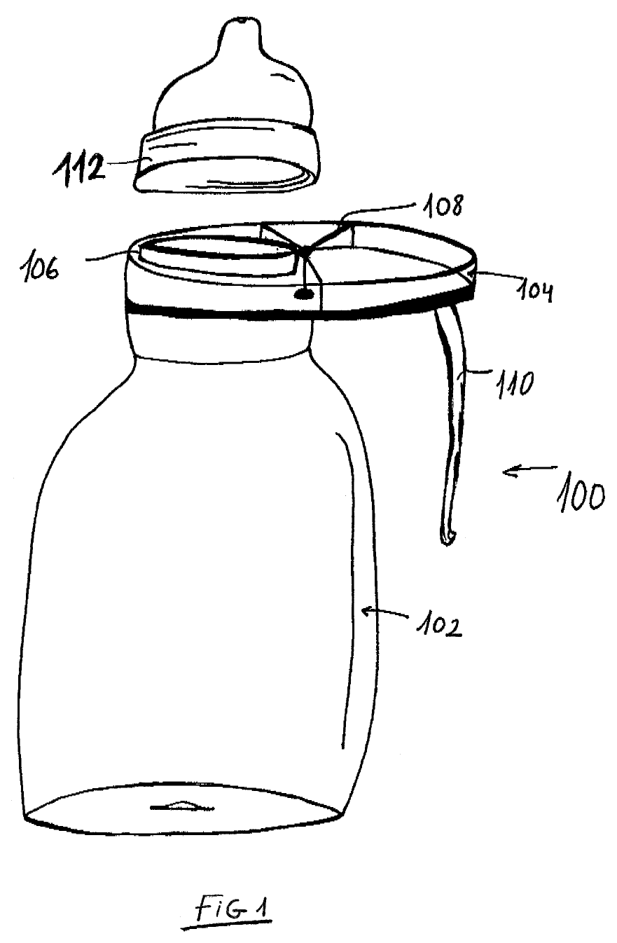

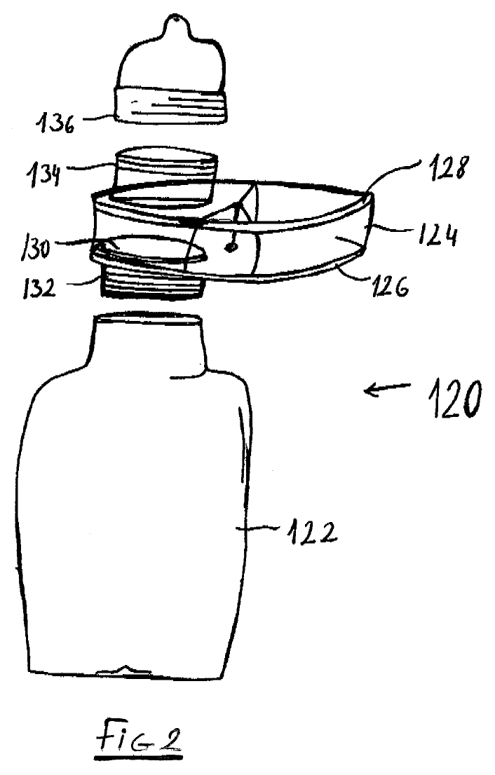

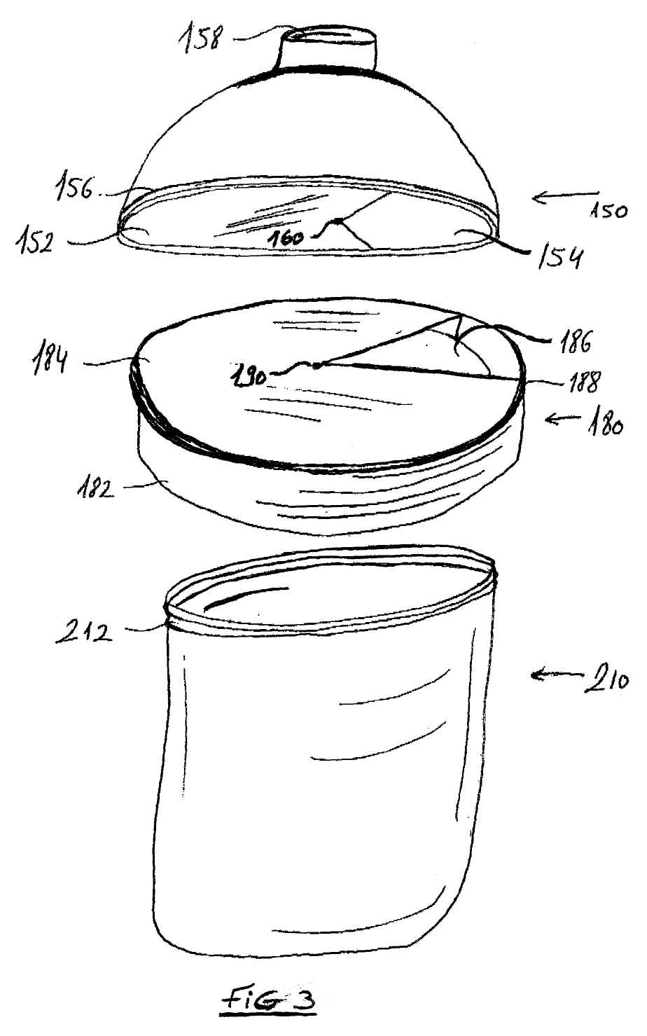

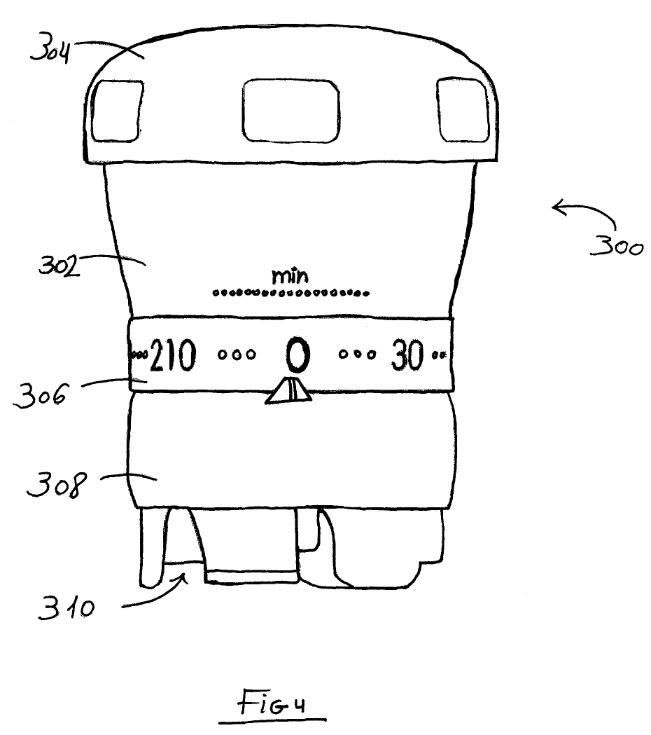

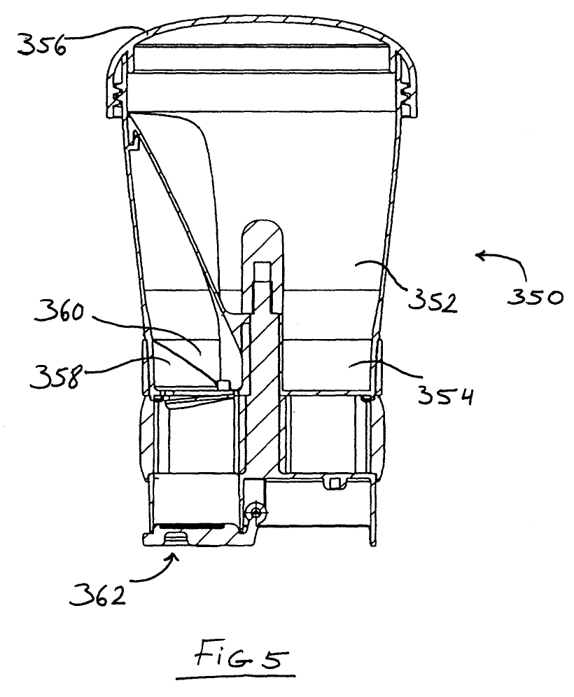

### BACKGROUND OF THE INVENTION

The present invention innovates with a device that is may be placed as a cover on top of a baby food powder storage container, for the purpose of quickly measuring the desired amount of powder, adjusted for the amount of water, and the amount of food to be given to the baby, and also enables an additional use of the invention, which is storage of baby food powder, and implementing and connecting the device as an integral part of the baby bottle, thus making it ready for quick preparation of food, without involving difficulty or attention beyond the minimum required, at such time as the user desires to prepare it.

Measuring the required amount of powder to add to a bottle containing a certain amount of water, a baby bottle differs based on the amount of water, and also with respect to the amount of powder distributed from the powder container, which can change. As is well known, in day to day life this action is done using a plastic spoon provided within the powder's storage box. The measuring process with the spoon, as is well known, is imprecise, and results in messy surroundings, and in general its use is clumsy and inefficient.

The preparation of baby food from a combination of powder and water, using the appropriate amounts, for example, based on the manufacturer's instructions, is an action that is well known to any father and mother. When the consumer is a newborn baby, and the baby's needs know no bounds, for example when it is hungry, the baby frequently breaks out in screams and cries, whether at night, or at other times that are inconvenient for an adult, for example, while driving a car.

In any of these cases, a solution is needed that is efficient, cheap and quick for the baby, enabling quick and efficient measuring of powder, as well as provision of the completed product, that is, the milk, which is central in importance for the baby's needs. Since the need for preparation of baby food requires both measured food powder and water, which is measured in proportion to the amount of powder, and where the common occurrence is that the one who prepares baby food needs to place several spoonfuls of powder into a narrow bottle, where the amount of water is measured and poured in real time, and considering that these actions take time, and are usually not done in the area of the child, for example in the kitchen, etc.

The present invention has the goal of providing a solution for these problems, and enabling quick measurement using a fitted device that serves as a cover for the powder box, and also optionally, another use of the present invention is to enable advance preparation of a baby food bottle in a single device, in which both parts of the device, and the bottle with the water, are separate from the food powder, which is held in a separate compartment of the present invention, and connected to the bottle. The present invention, then, enables immediate mixing, when desired, of the two components of which baby food is made, such as porridge, or baby milk.

The present invention has particular importance since preparation and mixing of the current food components cannot be done in advance, before the baby wishes to eat, since once the food powder is mixed together with the water, there is a limited period of time, at most a few hours, after which it is not recommended for health reasons to give the food to babies, due to considerations relating to the freshness of the food.

There is a significant need for a device that solves these problems, and that enables preparation of food in an immediate timeframe, without requiring complex physical activities of measuring, pouring, and the like.

The present invention improves and proposes efficient solutions, as specified herein.

### SUMMARY OF THE INVENTION

The purpose of the invention is to supply the user with a device that is an integral part, or can be connected, to a device for storage of baby food, for example as a part that connects as a cover to the box of baby food powder, as is commonly sold and used today.

The device will be connected as a cover to the powder storage container, using different connection methods that are made possible by simple and well known technologies, such as screwing, or applying pressure with the fingers, using a structure appropriate for this purpose.

The device of the present invention is comprised of at least two parts, with the lower part coming into contact with the powder in the storage box, at such time as the user turns over the storage box for the purpose of pouring the powder out, where at least part of the interior surface is open to receive the powder from the container. It will have another upper part in its regular state, before pouring and rotating over the powder container, with part of its lower interior surface being openable or closable, enabling continued pouring of powder from the lower part, and allowing one to close it once the desired amount of powder has been poured out. This is done in such way that the closing and opening of the interior surface that comes into contact with the bottom part is achieved by rotating the two parts of the device over a shared axis.

The upper part of the device is built according to a desired and predefined size, or is replaced with a different upper part of a different desired size, one that is appropriate for containing a certain, different amount of baby food powder. This upper part of the device is the measuring component of the invention, and the total amount of powder it can contain is the measurement specified on it. When this upper part is filled with powder, its upper part can be opened, for example, the part that is closed by a cap, and which does not come into contact with the bottom part of the device, in order to pour the powder out of the device, for example into the baby food bottle intended for mixing, in proportion to the desired amount of water.

The device of the present invention can also optionally be used as the closeable part of the baby bottle itself, and for this purpose serves as a measuring tool and storage device, and also enables immediate mixing of the powder and water.

An additional application of the present invention enables a distribution device that stands as an independent device, and does not connect to a bottle, but rather contains the powder distribution device, and when the powder is poured out of the device, for example, to the opening of a baby food bottle located underneath the device, opposite the opening where powder is poured out of the distribution device.

### BRIEF DESCRIPTION OF THE DRAWINGS

The drawings accompanying this patent request are intended to provide a more detailed description of the invention, and are included as part of this specification. The drawings show various forms of the device, and along with the description, serve to explain the underlying principles and manner of use of the device, all by way of example only, and not in order to limit the invention to the descriptions, or only to them.

Drawing 1 is a schematic representation showing an example included in the description of the present invention, and which shows an application for the device of the present invention which is intended for application and connection as part of a baby bottle, as shown in the drawing.

Drawing 2 is a schematic representation showing an example included in the description of the present invention, and which shows an application for the device of the present invention which is intended for application and connection as part of a baby bottle, as shown in the drawing.

Drawing 3 is a schematic representation showing an example included in the description of the present invention, and which shows an application for the device of the present invention that is intended for application and connection as a storage container for baby food, for the purpose of quick and efficient measuring, as shown in the drawing.

Drawing 4 is a schematic representation showing another application included in the application of the present invention, and which shows an application of the device in the present invention intended to stand independently on a surface, enabling distribution and pouring of powder from the device to a feeding tool such as a baby bottle, to be positioned opposite the exit opening area from which the baby food powder is poured out, for the purpose of distribution and transfer, and speedy and efficient measuring, as shown in the drawing.

Drawing 5 is a section of the device that may be opened and closed to enable the transfer of powder from the upper part of the device to its bottom part, as described in Drawing 4 above, and is intended to stand independently on a surface, enabling the distribution and pouring of powder from the storage container to a feeding tool such as a baby bottle, which is positioned opposite the opening where the baby food powder gets poured out, for the purpose of distribution and transfer, and speedy and efficient measuring, as shown in the drawing.

### DETAILED DESCRIPTION OF THE PREFERRED EMBODIMENTS

Drawing 1 is a schematic representation showing an example included in the applications of the present invention, and which shows the device 100 connected, as a separable or integral part, to a baby bottle, to facilitate preparation of baby food. The device of the present invention can also be connected to the opening of a baby bottle 106, and may contain at least one or more storage containers 108, such as one compartment among those shown in the drawing, with each compartment possibly having different sizes from the others, for different purposes, in order to meet the changing needs and requirements of the person preparing the baby food mixture. The compartment 108 serves to store the baby food powder, such that when one desires to prepare baby food, which requires mixing the powder with the corresponding amount of water, the user mixes the compound, and rotates the storage device in such way that the part of the device containing a compartment of measured powder, such as 108, reaches a position opposite the opening of the bottle, and the powder gets poured out of its lower closed part, and enters the flat surface of the open bottom part of the device, which is opposite the opening of the bottle, such that the powder is poured into the bottle, and all that is left to do is mix the water and powder together inside the bottle, for the purpose of immediate and easy preparation of a meal of baby food. The outer part of the device 104 can be used to rotate the device on its axis, until the compartment with the required amount is accordingly positioned opposite the opening of the baby bottle 102. Part 104 contains a lower surface area, which serves as the closing and opening door, and also rotates around the same axis, while the rotation and opening of the door is done when the desired compartment is ready and positioned opposite the opening of the baby bottle 102, as described. A rotating handle 110 also enables, in situations involving use of the device of the present invention, continued comfortable and efficient use for the baby, and the upper part of the bottle 112 is built like the well known structure of commonly used baby bottles, except for the possibility of fitting a closing or adapting element as required, and optionally for the purpose of fitting the additional components included in this invention, as opposed to the situation that exists today, as shown in the drawing.

Drawing 2 is a schematic representation that shows an example included in the application of the present invention, and in which the device 102 is connected as a separable or integral part of the baby bottle 122, used for preparation of baby food, and the device in the present invention can also be connected to the opening of the baby bottle, and may, using the screw adapter 132 as an example, rotate along with the axis of the lower part of the device, in such way that enables it to reach the various compartments based on needs and requirements, such that, when the preparation of baby food is desired, which involves mixing the powder with the appropriate measure of water, the compound is mixed, and the user rotates the storage device 124 in such way as the part of the device that contains the compartment with a measured amount of powder, reaches becomes positioned opposite the opening of the bottle 130, and an additional rotation of the double handle with opening 126 is enables pouring of the powder from the lower closed part, and enters the lower, open part of the device, that is positioned opposite the opening of the bottle, causing the powder to be poured into the bottle, and all that is left to do is mix the water and powder together in the bottle, for the purpose of immediate and easy preparation of a meal of baby food. The upper part of the device 134 that connects to the upper part of the baby bottle 136, can be closed and separated from the powder, and also from the mixed food, and enables, when opened, the feeding of the baby at the desired time, in a way that enables an extension of the freshness period of the mixed food in the bottle 122 and the device.

Drawing 3 is a schematic representation showing an example included in the applications of the present invention, and which demonstrates the purpose of the invention, by providing the user with a device that is a separable or integral part of the device for storage of baby powder 201, for example as a part that connects as a cover to the box of baby powder 210, as is commonly sold and used today. The device can be connected to the powder storage container 210 using various methods of connection, enabled by simple and common technologies, such as screwing 212 and 182. The device of the present invention includes at least two parts, a lower part 180 which comes into contact with the powder inside the storage container 210 when the user rotates the storage container in order to pour out the powder, where at least part of its interior surface is open in order to receive the powder from the container. Another upper part 150, whose lower internal part 152 and 154 can be opened or closed, enables continued pouring of the powder from the lower part 180, and can be closed when the desired amount of powder has been reached. The closing and opening of the internal surface that comes into contact with the lower part is done by rotating the two parts of the device on a shared axis 190 and 160. The upper part of the device 150 is in accordance with the desired and known measuring size, or is replaced with a different upper part, of a different desired size, appropriate for containing a different amount of powder. This upper part of the device is the measuring tool of the invention, and the total amount of powder it can hold is the measurement displayed on it. When this top part is filled with powder, its upper side can be opened, for example the part that is closed with a cap 158, which does not come into contact with the lower part of the device, enabling pouring of powder outside the device, for example into a baby bottle in which the powder is to be mixed with the appropriate amount of water.

Drawing 4 is a schematic representation showing another application included in the present invention, and which shows an application of the device 300 in the present invention, intended to stand independently on a surface, enabling distribution and pouring of powder from the bottom part 310 of the device to a feeding tool, such as a baby bottle, positioned opposite the exit opening for the baby food, for the purpose of quick and efficient distribution, transferring and measuring, as seen in the drawing. The device 300 includes a cover 304, which enables opening a part of the device's interior 302, through which, and to which, baby powder is transferred in order to be stored and poured out, and where the bottom of the powder storage area 302 includes a rotating mechanism 308 which is divided into compartments, with each compartment containing a minimal amount, according to the commonly used and recommended measurements for filling baby bottles, in such way as rotating part 308 on its axis creates in each transfer of the compartment inside it, a stop click, which notifies the user that one measuring unit has been transferred to the bottom of device part 310, and where if the user wants more than one measuring unit of powder, they can rotate the axis 308 for the number of clicks representing and marking the transfer of another unit of powder to the bottom of the device 310, and where the powder, in its desired and measured amount, is transferred to the bottom of the device 310, and is moved to the opening, which includes an optional cap, under which, for example, the baby feeding bottle is placed, whose upper part is open and ready to receive the powder that is being poured into it.

Drawing 5 is a schematic representation of a section of the device 350 described in drawing 4 above, which is intended to stand independently on a flat surface, and enables distribution and pouring of the powder from the device to a feeding tool such as a baby bottle, which is placed opposite the location where the baby food powder gets poured out of the device, for the purpose of quick and efficient distribution, transfer and measuring, as shown in the drawing. The cover 356 enables closing and opening of the interior of the device 352, which is intended to store powder for distribution, such that when the axis 354 is rotated, the powder in the compartments is transferred as 360 and 358, which passes during the transfer through opening 360, thus filling of part of the empty compartment with powder, and with another rotation, to area 358, preventing pouring of powder from above, while emptying the compartment into the lower opening 362, and alerting the user with a clicking sound with each rotation, indicating that another measured unit, based on the size of the compartment, has been transferred, and transfers the measured unit of powder in each compartment to the lower opening 362 of the device 350, to the storage container in which the powder is to be mixed with the water in order to prepare food for the baby.

In the device itself, each container can hold an amount of powder suitable for 30 ml. of water, such that, for example, a 180 ml. bottle requires rotating the device for 6 clicks, which is equal to 6 measuring units of the device. In addition, there is an optional feature that would have a measuring ruler displayed on the device, indicating the amount (0, 30, 60, 90, and so on).

Each user can rotate the device for the amount they need to prepare at that time, for example 240 ml. (8 clicks), 90 m. (3 clicks), or 270 ml. (9 clicks). In addition, the ruler that moves when the axis is rotated, shows the user the amount in ml., and after they have finished, they may again rotate the ruler to the starting point—0, and so on. The ruler rotates only in one direction, and is located on the external part of the device, meaning there is no problem rotating it back by completing a full rotation.

1. A device enabling connection to the baby powder storage container, such as a part that connects to the cap of a baby powder box, where the device of the present invention contains at least two parts: a lower part that comes into contact with the powder inside the storage container when the user turns over the storage container for the purpose of pouring out the powder, where at least part of its interior surface is open to receive the powder from the container. Another upper part is present in the normal condition, before pouring and turning over the powder container, where the part of the bottom surface can be opened or closed, in such way that allows continued pouring of the powder from the lower part, into the upper part, and may be closed when the desired amount of powder has been poured out.
Closing and opening of the interior part that comes into contact with the lower part can be done by rotating the two parts of the device on a shared axis.
The upper part of the device is fitted and built according to a desired and known measurement, or is replaced with another upper part of a different desired measurement, and is designed to contain a different amount of powder desired by the user.
This upper part of the device is the measuring tool in the invention, and the measurement displayed on it represents its content when filled with powder. When the upper part becomes filled with powder, the upper part can then be opened, for example the part that is closed by a cap, and which does not come into contact with the lower part of the device, enabling pouring of the powder outwards, for example into a baby bottle in which the appropriate amount of water is to be mixed with the powder.

2. A device as described in claim 1, where the device allows the connection as a cover to the powder storage container, by means of various connection methods made possible by simple and commonly known technologies, such as screwing, or pressured grip, using a structure built for this purpose.

3. A device as described in claim 1, including an optional addition to the device in the present invention which acts as a fitted part that connects a certain part of the baby bottle itself, and is used accordingly for this purpose as a measuring tool, and also as a storage container, and to immediately mix the powder and water.

4. A device as described in claim 1, where the device is an integral, built in part of at least some parts of the baby feeding bottle.

5. A device as described in claim 3, where the device is an integral, built in part of at least some parts of the baby feeding bottle.

6. A device as described in claim 1, where the device includes at least one rotatable central axis, and where the rotation of a central axis of this kind creates an opening for transfer of powder, or closes the transfer opening, to enable transfer of powder between at least two compartments in the device for transferring the baby food powder from one compartment to another, when the device is turned over in such way that the bottom part of the device becomes the top part, and gravity causes its contents to fall into the bottom part, which was the upper part in the state before the device was turned over, and where a door on the upper part of the device before it was turned over can be opened, in order to enable transfer of its contents of powder out of the device, or into a baby feeding bottle.

7. A device as described in claim 3 and claim 5, including at least one rotatable central axis, and where the rotation of a central axis of this kind enables creation of an opening for transfer of powder, or closing the transfer opening, between at least two compartments in the device, for transfer of baby food powder from one compartment to another, and created upon opening the upper door of the device, thus pouring baby food powder into the upper compartment, which is the measuring compartment for the required amount, and which, when filled, contains the required measurement amount displayed on it, and when the user wishes to mix the powder with the water in the bottom part of the bottle, the user rotates an axis including a surface that separates between the upper part that contains the powder, and the surface that contains an opening on part of its surface, until the opening in the separating surface is parallel at least in part to the opening of the bottle underneath it, thus facilitating the pouring of powder into the interior of the bottle containing water or liquid.

8. A device intended to comfortably store and distribute baby food powder, where the device includes, at least, an empty space in which the baby food powder will be stored, and where:
A certain area in the bottom of the empty storage container includes an opening door, and where;
An additional area under the part of the storage container enables pouring of a controlled amount of powder from the empty part of the device, or which prevents the powder from escaping from the empty part of the device, owing to this part of the device, which is built as follows:
This part of the device, including an interior surface connected to the bottom part of the storage container, which prevents the powder from falling from the lower opening of this part of the empty device, in the state where the lower part of this part of the device is completely filled with powder.
A certain part of the upper interior surface of the device includes gaps, or openings, which are used accordingly in different situations, according to their order, in parallel with the lower opening of the storage compartment that is above it, where a certain part of the powder from the upper storage compartment falls through the opening section of this part of the device,
And where;
This part of the device also includes an hollow internal storage area, in which part of the upper ceiling comes into contact with the part of the upper compartment, and between its bottom surface part, where part of this container is divided into compartments using internal dividing walls, and external walls which prevent the powder from falling out of the device from its sides, and where;
Part of this device includes a central axis enabling rotation of this part of the device on its axis, while the upper storage compartment remains in place, and where;
The rotation of this part of the device is enabled by the user gripping the upper part of the device, and rotating the lower container part, where such rotation is indicted by bumps, or teeth, located on the border of each wall of a storage compartment, and where;
This part of the device would optionally, in its external part, display the amount using a ruler indicating the measured amount, opposite each compartment and each bump indicating the end of one compartment area, and with an option to continue transferring to another compartment, such that:
Rotating this part of the device on its axis enables filling the hollow compartments of this part of the device, and where:
The bottom part of this part of the device is not connected, and does not rotate on the rotating axis of this part of the device, and includes at least one opening, of the same size as the part of at least one other compartment of this part of the device, with each rotation of this part of the device results in one compartment being positioned opposite the opening of the bottom part, thus enabling pouring of a known and measured amount of powder outside the device, and to an external storage device intended to receive the powder, and to use it to prepare baby food, and where;
Optionally, a liquid transport device such as a funnel can be installed in the part where the powder falls out of the device into an external container, in order to facilitate ease of use and precision in transferring the powder to the external container.

9. A device as described in claim 8, where the size of the compartments enables pouring of powder according to a known measurement, that is 30

10. A device as described in claim 8, where the rotating axis does not move the upper storage parts or the storage parts that serve as measuring compartments, such that rotation of the axis affects only the bottom part of the device, which is located under the compartments for storage and distribution of powder, in such way that each rotation of the axis rotates the delimiting floor surface, and prevents the powder from falling out of the compartments, except for at least one compartment which is located in the area of at least one opening, located on the lower rotating surface, such that with each rotation of the measuring compartment, characterized by clicking or stopping of the gear tooth or bump of a compartment with a gap located on the bottom part of the rotating surface, another compartment containing powder becomes positioned opposite the opening, and another amount of measured powder is poured out.

11. A device as described in claim 10, where at least one compartment contains a measured amount of powder, positioned opposite the opening of the lower rotating part, which upon reaching the lower opening area, becomes positioned above it, and the lower surface of the upper storage container will has a stopping lower surface that prevents powder from falling the storage container into the measuring compartments, such that when the contents of the compartment are poured out of the device, the compartment space does not become filled with powder from the hollow upper storage part of the container.

12. A device as described in claim 10, where the storage compartments are connected to the rotating axis, and they rotate, and do not include a closing upper top part, or a closing bottom part connected to the opening and closing parts, and bottom and top parts of the compartments, respectively, are positioned in the upper storage container and under the distribution compartments, and include openings in the area that enables the purpose of the invention, as described in each part of this patent request.
